(19) United States
(12) Patent Application Publication
(10) Pub. No.: US 2026/0260178 A1
(43) Pub. Date: Sep. 3, 2026

(54) PREDICTION APPARATUS, MODEL CONSTRUCTION METHOD, AND PROGRAM

(71) Applicant: NIPPON TELEGRAPH AND TELEPHONE CORPORATION, Tokyo (JP)

(72) Inventors: Helen STEWART, Tokyo (JP); Takashi FURUTANI, Tokyo (JP); Masaki HISADA, Tokyo (JP)

(21) Appl. No.: 18/865,499

(22) PCT Filed: May 24, 2022
(86) PCT No.: PCT/JP2022/021309

§ 371 Date: Nov. 13, 2024

(51) Int. Cl. G06Q 10/04; G06N 20/00

(52) U.S. Cl. CPC G06Q 10/04; G06N 20/00

(57) ABSTRACT

A prediction device includes: an acquisition unit configured to acquire time-series data of a food loss coefficient and one time-series model parameter or a plurality of time-series model parameters; and a model construction unit configured to construct a time-series model for predicting a future food loss coefficient using the time-series data of the food loss coefficient and the one time-series model parameter or the plurality of time-series model parameters.

### TECHNICAL FIELD

The present invention relates to a technique for predicting a food loss coefficient.

### BACKGROUND ART

Sustainable Development Goals (SDGs) require a worldwide reduction of food waste. Therefore, quantifying food loss is important in order to measure the progress toward food loss reduction goals and identify points for preventing food loss. As a scheme for quantifying food loss, there is a mass flow analysis (MFA) technique (NPL 1). In the MFA technique, analysis is performed based on a food loss coefficient which is a ratio of an amount of loss to an amount of food flowing in each step of a supply chain.

### CITATION LIST

### Non Patent Literature

NPL 1: C. Caldeira, V. De Laurentiis, S. Corrado, F. van Holsteijn, and S. Sala, “Quantification of food waste per product group along the food supply chain in the European Union: a mass flow analysis,” Resources, Conservation and Recycling, vol. 149, pp. 479 to 488, October 2019.
NPL 2: “Impact of food wastage on water resources and GHG emissions in Korea: A trend-based prediction modeling study—ScienceDirect.” https://www.sciencedirect.com/science/article/abs/pii/S0959652620326093 (accessed Mar. 14, 2022).

### SUMMARY OF INVENTION

### Technical Problem

However, in the technique of the related art, a food loss coefficient that greatly affects the accuracy of mass flow analysis is determined based on direct investigations and interviews at a given time point, and since the coverage in each of processes of distribution may not be sufficient and coefficients of several years ago may be used in a fixed manner, it is difficult to reflect frequent changes made due to consumer behavior and climate change.

In the technique of the related art, since the food loss coefficient can be obtained only with a very low time resolution, it is difficult to predict a future food loss coefficient.

The present invention has been made in view of the foregoing circumstances, and an object of the present invention is to provide a technique capable of predicting a future food loss coefficient.

### Solution to Problem

According to an aspect of the disclosed technique, a prediction device includes: an acquisition unit configured to acquire time-series data of a food loss coefficient and one time-series model parameter or a plurality of time-series model parameters; and
a model construction unit configured to construct a time-series model for predicting a future food loss coefficient using the time-series data of the food loss coefficient and the one time-series model parameter or the plurality of time-series model parameters.

### Advantageous Effects of Invention

According to the disclosed technique, a technique capable of predicting a future food loss coefficient is provided.

### BRIEF DESCRIPTION OF DRAWINGS

FIG. 1 is a diagram illustrating a flow of MFA calculation.

FIG. 2 is a diagram illustrating an overview of food loss coefficient prediction.

FIG. 3 is a diagram illustrating a configuration of a food loss prediction device 100 according to an embodiment of the present invention.

FIG. 4 is a diagram illustrating an example of a data structure obtained by the data processing unit 130.

FIG. 5 is a diagram illustrating construction of a model by a loss coefficient model construction unit 210.

FIG. 6 is a diagram illustrating an example of data input to the model.

FIG. 7 is a flowchart illustrating a flow of processing.

FIG. 8 is a diagram illustrating a hardware configuration example of a device.

### DESCRIPTION OF EMBODIMENTS

Hereinafter, an embodiment of the present invention (present embodiment) will be described with reference to the drawings. The embodiment to be described below is merely exemplary and an embodiment to which the present invention is applied is not limited to the following embodiments.

Hereinafter, when a food loss prediction device according to an embodiment of the present invention is described, a related technique will first be described. Literature referred to in description are indicated by “[1]” and the like and the details corresponding literatures are listed collectively at the end.

### (Food Loss)

According to the U.N. Food and Agriculture Organization (FAO), one third of the food produced for human consumption is wasted [1]. Food waste means inefficient use of scarce resources including land, water, labor, and emission of unnecessary greenhouse gases and is a problem of both environment and economy.

Food waste also results in ethical challenges in global societies. The number of people facing severe food insecurity is also increasing. In 2020, approximately 928 million people or nearly 12% of the world population face serious food shortages, which represents an increase in 148 million people compared to 2019 [2].

Based on this situation, the U.N.set a sustainable development goal (SDG12.3), “By 2030, halving per capita global food waste at the retail and consumer levels and reducing food losses along production and supply chains, including post-harvest losses” and appealed an endeavor to reduce food loss all over the world [3].

Food is lost or wasted at various time points (hereinafter, loss and waste are referred to collectively as “loss”) from primary production of food in farm and pasture until reaching the fork of the consumer (Farm to Fork). The “loss” referred to below may be replaced by “damage”, “waste”, or the like.

A ratio of an amount of loss to an amount of food varies depending on a food category or a step of a supply chain. Therefore, to achieve the food loss reduction target of SDG12.3 it is necessary to take the whole supply chain into account. An important step of reducing food loss is to develop accurate and timely methods of quantifying the food loss. The qualification of the food loss is required in order to measure a progress status toward food loss reduction targets and to identify points on a supply chain with more preventable food loss.

In techniques of the related art, food loss quantification methods are still in initial stages and there are various ranges of investigation or the like, the results thereof are difficult to compare and interpret, and the accuracy is also low.

### (MFA)

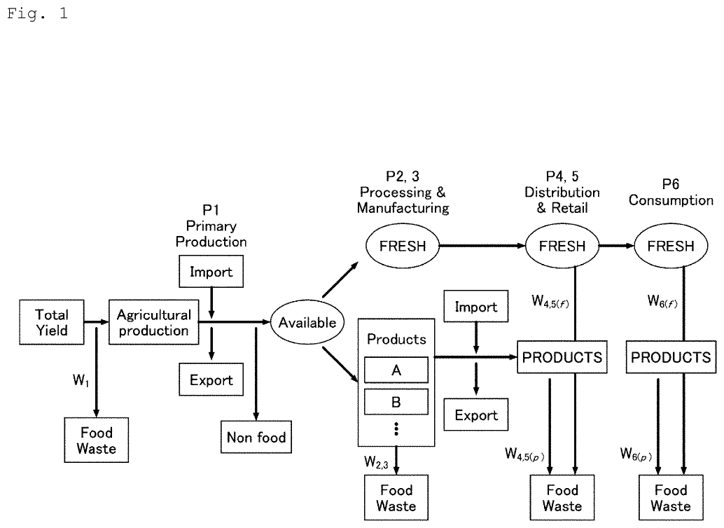

In order to solve the above problems, a mass flow analysis method (MFA method) has been proposed [4]. FIG. 1 illustrates a flow of MFA calculation used in [4]. As illustrated in FIG. 1, the quantification of food loss of the MFA is divided into six stages in a supply chain. In FIG. 1, W_{n(f/p)} indicates each food loss coefficient of fresh (f)/processed food (p) in an n-th step (stage) of the supply chain. Steps P1 to P6 of the supply chain respectively indicate P1: Primary production, P2: Production, P3: Processing, P4: Distribution, P5: Retail, and P6: Consumption.

In calculation of the MFA method, the food loss coefficient W_{n(f/p)} is used as the percentage of food loss (loss or discarded) in each step of the supply chain and is an important value related to the accuracy and precision of entire analysis. In the techniques of the related art for the MFA, the food loss coefficient is not directly calculated, and fixed values based on investigations and interviews from various literature sources are adopted. However, in practice, it is considered that the food loss coefficient varies depending on an action of a consumer or the like.

In Reference Literature [5], food loss is predicted at a yearly time resolution by linear regression using a mass flow analysis method.

However, the technique of the related art disclosed in [5] does not suffice for a time resolution. Since fresh food rots on a weekly time scale, prediction of a yearly time resolution does not suffice for positively redirecting food resources and a reduction in food loss.

Actual food loss varies very dynamically and is affected by many factors along the supply chain. However, in the technique of the related art disclosed in [5], since a linear model is used for prediction of food loss, it is insufficient to model such complicated food loss. Further, since a resolution of data is low, the number of data points does not suffice for use of a nonlinear model.

There are the following three problems as problems of the techniques of the embodiment with respect to the techniques of the related art such as [5].

First, for a time resolution of prediction, in the technique of the related art, there is no food loss prediction technique at a macro level (for example, a city, an area, a nation, or the like) on a time scale (high time resolution) on which an active endeavor to reduce the loss along a supply chain can be made.

Secondly, a linear modeling scheme used in the technique of the related art does not suffice for modeling of very complex and dynamic properties of the food loss.

Thirdly, to model a highly nonlinear nature of the food loss, time-series data regarding loss having time resolution of, for example, from a daily basis to a weekly basis is required. In order to accurately predict tends in food loss at a macro level, the tendency of weather, news, social tendency, or the like, time-series parameters of other high time resolutions are required that affect food production and consumption levels.

The above problems are solved by the technique according to an embodiment to be described below.

### (Overview of Embodiment of Present Invention)

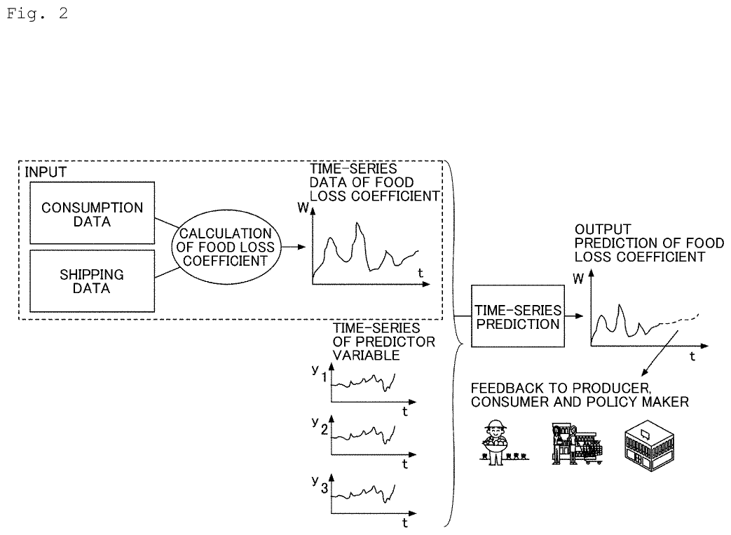

An overview of prediction of a food loss coefficient by a food loss prediction device (which may be referred to as a “prediction device”) according to the present embodiment will be described below with reference to FIG. 2.

First, as illustrated in a frame of “INPUT” of FIG. 2, data of a food loss coefficient (time-series data) is calculated using consumption data (for example, POS data) and shipping data (for example, statistical data). The data to be calculated here is present data (real-time data) or past data. In the present embodiment, it is possible to estimate time-series data of a food loss coefficient with a higher time resolution than in the technique of the related art.

A time-series model is constructed (trained) using the calculated (estimated) time-series data of the food loss coefficient and the time-series data of a predictor variable (for example, temperature). The predictor variable may be referred to as a “time-series model parameter”.

The time-series model is, for example, a neural network model. In learning for the time-series model, learning is performed so that future time-series data later than a certain period can be predicted from time-series data for the certain period.

Then, a future food loss coefficient later than the period is predicted by inputting time-series data of a food loss coefficient for the certain period and the time-series data of the predictor variable (for example, temperature) to the trained time-series model.

For example, a future food loss can be predicted from a predicted future food loss coefficient and the future food loss can be fed back to a producer, a consumer, a policy maker, and the like.

Food loss over the entire supply chain of food can be predicted using the predicted time-series data of the food loss coefficient. An information can also be fed back to producers and consumers to encourage them to take action to reduce food loss. A prediction result of the food loss can also be used to strategically turn surplus food in the primary production stage of the supply chain to a field required in a subsequent stage.

In the present embodiment, a model for predicting time-series data is referred to as a time-series model. A time-series model capable of modeling a nonlinear event can be referred to as a nonlinear time-series model. Although the nonlinear time-series model is not limited to a specific model, for example, there is a model using LSTM, a model using a Gaussian process, or a model using a transformer as the nonlinear time-series model.

Hereinafter, a food loss prediction device (food loss coefficient prediction device) will be described in detail as a more specific embodiment. Both the food loss prediction device and the food loss coefficient prediction device may be referred to as prediction devices.

### (Method of Calculating Food Loss Coefficient)

First, a method of calculating the food loss coefficient executed by a loss coefficient estimation unit 140 of the food loss prediction device 100 to be described below will be described.

Here, a food loss coefficient W_{4,5(f)} used for P4 and P5 (distribution and retail) in the MFA illustrated in FIG. 1 will be described as an example. Since an expiration date of fresh food is short, a possibility of being wasted being higher than processed food. A total loss ratio of vegetables and fruits in a fresh food category is the highest among all categories. However, accuracy of quantification is the lowest. Accordingly, in order to reduce the food loss, it is necessary to improve the accuracy of loss quantification of vegetables and fruits.

Since fruits and vegetables do not require processing and manufacturing before distribution and retail, processing and manufacturing stages (P_{2,3}) are not required in calculation of the MFA. On the other hand, for fresh meat and seafood, it is necessary to take edible and non-edible parts (bones or the like) wasted in the processing process into account.

Although a result of an environmental investigation used in the MFA method of the food loss has been published irregularly, the range is often limited to a specific food category or a specific retail store. On the other hand, financial data regarding sales of food including food prices and point-of-sales (POS) information management data are updated daily, and there are pieces of data for all food categories sold at retail stores. However, the financial data and POS data are not used in the technique of the related art in the quantification of food loss.

In the present embodiment, a loss coefficient W_{4,5(f)} of fresh food in the distribution and retail stage of the supply chain is defined as follows.

$${W}_{4 , 5 ( f )} = 1 - ( {m}_{6} / {m}_{4 , 5} ) \qquad Formula 1$$

Here, m4,5 is a food mass flow [kg] ((P₁→P_{4,5}) or (P_{2,3}→P_{4,5})) flowing from a primary production stage (in the case of fruits and vegetables) (a processing stage in the case of animal products) to a distribution and retail stage. m₆ is a food mass flow [kg] (P_{4,5}→P₆) flowing from the distribution and retail stage to a consumption stage. m_{4,5} corresponds to a shipping amount of fresh food.

Data regarding m_{4,5} is publicized on the weekly basis by Ministry of Agriculture, Forestry and Fisheries, and thus this data can be used. On the other hand, m₆ can be calculated from the POS data by the following Formula (2).

$${m}_{6} = s / pr \qquad Formula 2$$

Here, s is total sales [yen] of the food updated once a day and taken from the POS data, r is a ratio of the POS data to the whole market, and p is a price [yen/kg] of the food. For p, in the case of fresh food, average prices are publicized once per week in Ministry of Agriculture, Forestry and Fisheries, and thus the average prices can be used.

By calculating W_{4,5} using Formulae 1 and 2, it is possible to raise temporal yearly accuracy or less in the related art to weekly accuracy for W_{4,5}. By using the POS data, it is also possible to obtain the W_{4,5} on a daily basis. As described above, targeting a loss coefficient of fresh food in the distribution and retail stage of the supply chain is merely an example. For example, by utilizing POS data and statistical data (or other data), it is also possible to calculate time-series data of the food loss coefficient with a high time resolution (for example, on a daily basis) for other types of food in other stages.

By tracking a product using an IoT technique instead of the POS data or in addition to the POS data, it is also possible to calculate the time-series data of the food loss coefficient with a high temporal resolution (for example, on a daily basis).

### (Configuration of Food Loss Prediction Device)

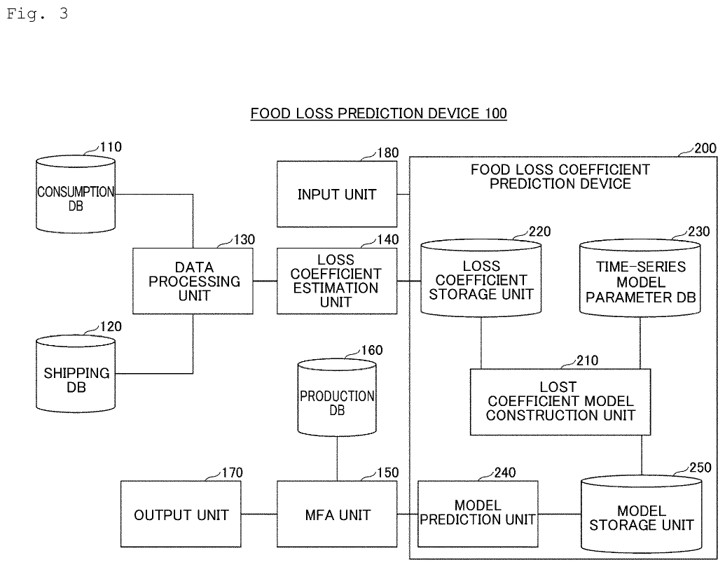

FIG. 3 illustrates a configuration example of the food loss prediction device 100 according to the present embodiment. As illustrated in FIG. 3, the food loss prediction device 100 includes a consumption database (DB) 110, a shipping DB 120, a data processing unit 130, a loss coefficient estimation unit 140, an MFA unit 150, a production DB 160, an output unit 170, an input unit 180, a loss coefficient model construction unit 210, a loss coefficient storage unit 220, a time-series model parameter DB 230, a model prediction unit 240, and a model storage unit 250.

The food loss prediction device 100 may be configured with one computer or a plurality of computers. A configuration including “the loss coefficient model construction unit 210, the loss coefficient storage unit 220, the time-series model parameter DB 230, the model prediction unit 240, and the model storage unit 250” may be referred to as a food loss coefficient prediction device 200. The food loss coefficient prediction device 200 may be connected via a network with a device including “the consumption database (DB) 110, the shipping DB 120, the data processing unit 130, the loss coefficient estimation unit 140, the MFA unit 150, the production DB 160, and the output unit 170”.

The food loss coefficient prediction device 200 may not include the model prediction unit 240. A device including the loss coefficient model construction unit 210 may be referred to as a learning device.

The input unit 180 illustrated in FIG. 3 inputs data which is used for prediction (for example, temperature time-series data, the number of days ahead to be predicted, or the like). The output unit 170 outputs a detection result of the food loss. The output unit 170 may output a prediction result of the food loss coefficient.

Each DB may be provided outside of the food loss prediction device 100 (the food loss coefficient prediction device 200).

The loss coefficient model construction unit 210 may be referred to as a “model construction unit”. A function in which the loss coefficient model construction unit 210 acquires data from the DB may be referred to as an “acquisition unit”. The DB may not be included in the device, and the input unit 180 may acquire data from an external DB and may input data to the loss coefficient model construction unit 210. In this case, the input unit 180 may be referred to as an “acquisition unit”. The model prediction unit 240 may also be referred to as a “prediction unit”. The MFA unit 150 may also be referred to as an “analysis unit”. Hereinafter, each unit will be described.

### <Consumption DB 110>

The consumption DB 110 stores the POS data acquired from the outside. Alternatively, the consumption DB 110 may be a DB of a POS service provider located outside of the food loss prediction device 100, as will be described below.

The consumption DB 110 stores information regarding daily sales of merchandise. When the data of the consumption DB 110 is data from which information regarding daily sales of merchandise can be obtained, any POS data may be used. In the present embodiment, data provided by “real shopper SM” service [7] by Shopper Insight can be given as an example. Purchase data (POS data) of the merchandise without a JAN code, such as fresh meat, fishes, fruits, and vegetables can be obtained by the “real shopper SM” service.

A food loss rate of fresh fruits and vegetables is about three times higher than that of processed products. Therefore, the fresh food is set as a food loss coefficient calculation target in the present embodiment. However, this is exemplary and the food loss prediction device 100 can also be applied to food other than fresh food. By using a weight equivalent coefficient for converting a weight of processed food into an equivalent weight of the fresh food, analysis of the fresh food can be expanded to the processed food.)

### <Shipping DB 120>

Ministry of Agriculture, Forestry and Fisheries (MAFF) provides, for example, data regarding seasonal production amounts and weekly product prices Data publicized from MAFF is stored in the shipping DB 120. Statistical data of MAFF is used as an example, and statistical data other than the data of MAFF may be used.

In the statistical data publicized from MAFF or the like, a format or the like is often not consistent. Therefore, in the present embodiment, in order to use the statistical data for automatic calculation, the statistical data is processed by the data processing unit 130 to be described below. The data processing unit 130 may also be referred to as an API unit 130.

### <Data Processing Unit 130>

In order to facilitate the calculation of the food loss coefficient, the data processing unit 130 processes the data acquired from the consumption DB 110 and the shipping DB 120 and retains the data in a storage unit (for example, a memory device 1003 or an auxiliary storage device 1002). Since the data processing unit 130 is a means for acquiring various types of data, the means may be referred to as an acquisition means or an acquisition unit.

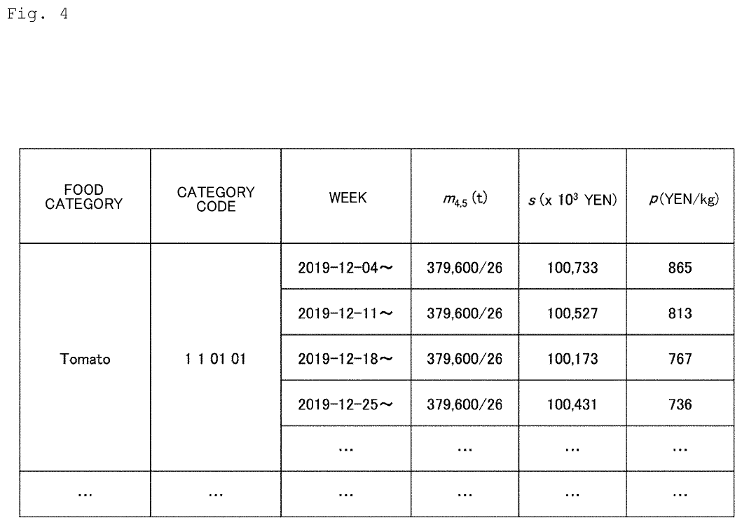

Specifically, processing or the like is performed to apply a code to data acquired from the consumption DB 110 and the shipping DB 120 for each food category, for example, on a weekly basis. FIG. 4 illustrates an example of the data structure obtained by the data processing unit 130.

As illustrated in FIG. 4, the storage unit stores a food category, a category code, a week, m_{4,5}, s, and p. m_{4,5} illustrated in FIG. 4 is a value based on the data obtained from the shipping DB 120. Specifically, the value is based on values obtained from vegetable harvest investigations in winter and spring seasons of Ministry of Agriculture, Forestry and Fisheries in 2019. Weekly shipping amounts in winter and spring seasons are obtained by dividing total shipping amounts of six months by 26.

s is a value obtained from the consumption DB 110, and p is a value obtained from the shipping DB 120.

### <Loss Coefficient Estimation Unit 140>

The loss coefficient estimation unit 140 calculates a food loss coefficient using, for example, the above-described Formulae 1 and 2. For example, the following values can be obtained by substituting the week data starting from 2019 Dec. 4 illustrated in FIG. 4 into Formulae 1 and 2.

$${m}_{6} = 100733 \times 1 {0}^{3} / 865 \times 0.018 = 6.47 \times 1 {0}^{6}$$

$${N}_{4 , 5 ( f )} = 1 - ( {m}_{6} / {m}_{4 , 5} ) = 1 - ( 6.47 \times 1 {0}^{6} \times 26 / 379 , 600 \times 1 {0}^{3} ) = 0.56$$

The above calculation results mean that 56% of produced tomato is wasted.

The loss coefficient estimation unit 140 can also calculate W₁, W_{2,3} and W₆ as follows.

$${W}_{1} = 1 - ( {m}_{4 , 5} / {m}_{1} )$$

$${W}_{2 , 3} = 1 - ( {m}_{4 , 5} / {m}_{2 , 3} )$$

$${W}_{6} = 1 - ( {m}_{fork} / {m}_{6} )$$

Here, m₁ is an amount (mass) of food produced in the primary production (P₁), m_{2,3} is an amount of food that can be eaten after the completion of the production and production (P2,3), m_{4,5} is an amount of food shipped to a retail store (P4 and 5), and m₆ is an amount of food purchased by a consumer (P₆).

For example, m₁ and m_{4,5} can be obtained from statistics of Ministry of Agriculture, Forestry and Fisheries (MAFF) [6]. m_{fork} can be obtained by calories of the food required for keeping the health of a person being converted into the amount of the food.

For example, m_{fork} can be calculated by the following formula.

$${m}_{f o r k} = \sum {p}_{i = 1} \sum {n\_cat}_{j = 1} {c}_{i} {g}_{j} {W}_{m , j}$$

The first Σ for “cᵢgⱼW_{m,j}” indicates a sum from j=1 to n_cat. n_cat indicates the number of food items. The following Σ represents a sum from i=1 to p. p is a population.

cᵢ indicates calories required for a person, and g; indicates a calorie ratio for each food item. They can be obtained from, for example, “U.S. Department of Health and Human Services and U.S. Department of Agriculture. 2015-2020 Dietary Guidelines for Americans. 8th Edition. December 2015. Available at http://health.Gov/dietaryguidelines/2015/guidelines/”.

W_{m,j} indicates a ratio (coefficient) for converting calories into a weight. This is acquired from, for example, “Bowman S A, Clemens J C, Friday J E, and Moshfegh A J. 2020. Food Patterns Equivalents Database 2017-2018: Methodology and User Guide. U.S. Department of Agriculture. Available at: http://www.ars.usda.gov/nea/bhnrc/fsrg”.

The acquisition of m₁, m_{2,3}, m_{4,5}, m₆, and m_{fork} by the above-described schemes is exemplary. Each can be acquired by a scheme with a higher time resolution (for example, on a daily basis) and the food loss coefficient with a high time resolution can be calculated.

The loss coefficient estimation unit 140 stores the calculated food loss coefficient (time-series data) in the loss coefficient storage unit 220. Although W_{4,5} is used as an example in model construction to be described below, the model construction and future time-series prediction can be performed for the food loss coefficients other than W_{4,5} as in W_{4,5}.

### <Loss Coefficient Storage Unit 220>

The loss coefficient storage unit 220 stores the time-series data of each food loss coefficient in units of food items such as soybean curd, beef, chicken, and potato calculated by the loss coefficient estimation unit 140. The stored data includes time-series food loss coefficients W_{4,5}(t).

### <Time-Series Model Parameter DB 230>

The time-series model parameter DB 230 stores time-series model parameters as predictor variables used in model construction (model learning). The time-series model parameter is, for example, data on a daily basis. The time-series model parameters include, for example, temperature, regional population, a social trend by SNS, and an economic index.

### <Loss Coefficient Model Construction Unit 210>

The loss coefficient model construction unit 210 inputs the time-series loss coefficients W_{4,5}(t) from the loss coefficient storage unit 220 and time-series model parameters such as temperature, population, and social emotion derived from social media from the time-series model parameter DB 230.

The data is used to construct a time-series model. The method of constructing the time-series model is not limited to a specific method. For example, time-series model can be constructed using a time-series modeling technique such as a multivariate LSTM, a Gaussian process, or transformer. The constructed model is, for example, a neural network model.

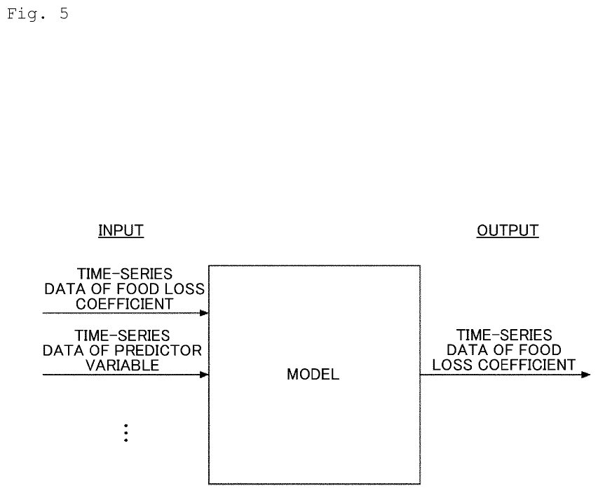

An image of model construction (and prediction based on the model) by the loss coefficient model construction unit 210 is illustrated in FIG. 5. The time-series data of the food loss coefficient and the time-series data of one predictor variable or a plurality of predictor variables are input to the model, and the time-series data of the food loss coefficient is output from the model. When the model is constructed, a parameter of the model is adjusted so that an error between the time-series data of the food loss coefficient of the output and the time-series data of the correct food loss coefficient (for example, future time-series data later than an input time-series data) becomes minimum. The constructed model is stored in the model storage unit 250. An actual state of the model stored in the model storage unit 250 is, for example, data including a function and a weight parameter.

For example, when there is time-series data for learning, the model can be learned by using a temporally early portion (for example, ⅔ from the beginning of the whole data) of the time-series data for an input and using a temporally later portion (for example, ⅓ of the remains) as a correct answer.

In the model prediction unit 240 to be described below, by using the constructed (trained) model, for example, it is possible to input “the time-series data of the food loss coefficient and the time-series data of one predictor variable or the plurality of predictor variables” in a certain past period (or from the past to the present) to the model, and obtain the time-series data of the food loss coefficient in a certain future period as an output.

### <Model Prediction Unit 240>

The trained time-series loss coefficient model is input from the model storage unit 250 to the model prediction unit 240. For example, a model for W_{4,5} is defined as W_{4,5} (t, x₁, . . . , xⱼ). The expression of the model represents that x₁, . . . , xⱼ intends to be used as a predictor variable.

In order to predict a future food loss coefficient, time-series data W of a past food loss coefficient and time-series data of each of j predictor variables (x₁, . . . , xⱼ) are input to the model in the model prediction unit 240. A value for designating the number of days ahead to be predicted from a time-series period of the input data is input to the model.

The model prediction unit 240 (model) outputs a predicted value of the future food loss coefficient in a designated n-time step later than a period of the input data. For example, when three months are designated, for example, past time-series data for one year is input, and the predicted value of the food loss coefficient from the present time after three months is output.

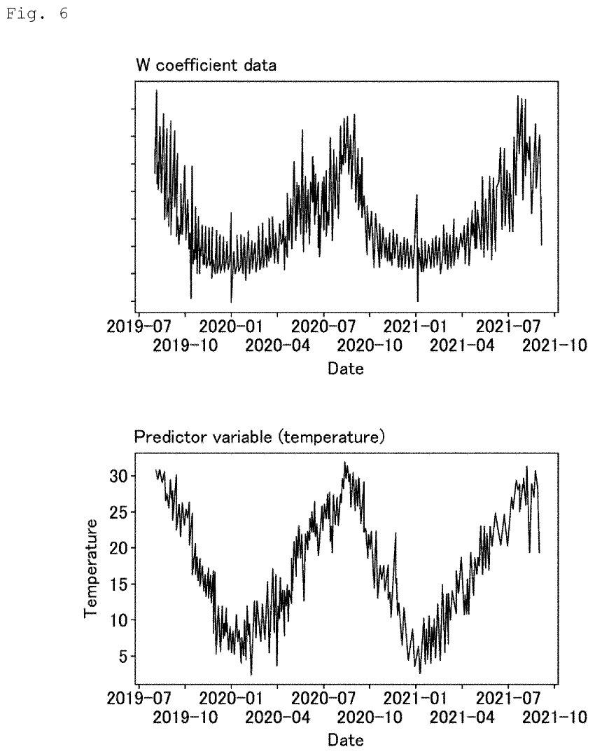

A construction example of a multivariate model based on LSTM will be described. FIG. 6 illustrates an example of input data (time-series data of a loss coefficient and temperature) to the model. In this example, it was confirmed that a root mean square error (RMSE) decreased by 12.5% compared to the multivariate model by using daily temperature as a predictor variable in a multivariate model

### <MFA Unit 150>

The mass flow analysis (MFA) unit 150 can predict the time-series data of the food loss using the time-series data of the food loss coefficient predicted by the model prediction unit 240. The MFA unit 150 can also calculate the food loss using the food loss coefficient calculated by the loss coefficient estimation unit 140 or the food loss coefficient stored in the production DB 160.

For example, the MFA unit 150 can calculate a sum of food losses of a particular food item over a supply chain. Here, it is assumed that the initial production mass m₁ is stored in the production DB 160.

The predicted values W₁, W_{2,3}, W_{4,5} and W₆ of the food loss coefficients of the primary production/processing (P₁), the production (P2, 3), and the consumption (P₆) are input from the model prediction unit 240 to the MFA unit 150, and the initial production mass m₁ is input from the production DB 160 to the MFA unit 150.

The MFA unit 150 calculates a predicted value of a total amount m_{waste} of food loss of a specific food group with respect to processed food by the following formula.

$${m}_{waste} = {m}_{1} {W}_{1} , {W}_{2 , 3} {W}_{4 , 5} {W}_{6} \qquad Formula 3$$

For fresh food and unprocessed food, the above formula can be simplified as follows.

$${m}_{w a s t e} = {m}_{1} {W}_{1} , W 4 , 5 {W}_{6} \qquad Formula 4$$

The foregoing calculation is exemplary. For example, it is also possible to obtain a predicted value of the time-series data of the food loss for each stage in the supply chain. For example, food loss in P4 and P5 can be predicted by mW_{4,5} (Formula 5) using the food loss coefficient W_{4,5} in P4 and P5 (distribution and retail) and an amount (referred to as m) of food in P4 and P5 (distribution and retail).

When the food loss with a high time resolution is predicted by calculating the foregoing Formulae 3 and 4, the food loss coefficient with a time resolution lower than the time resolution of the W_{4,5} may be used for, particularly, a food loss coefficient other than the W_{4,5} with large daily variation.

### (Flow of Processing)

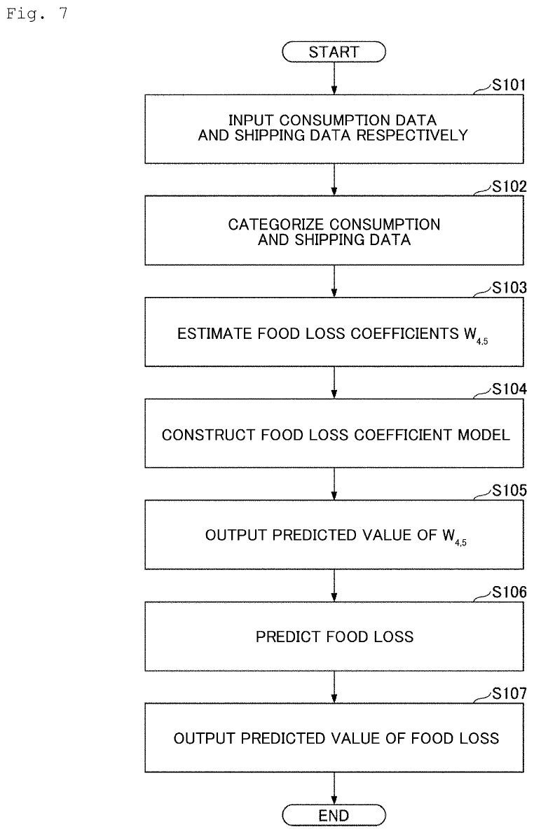

Next, an operation example of the whole food loss prediction device 100 will be described with reference to a flowchart of FIG. 7. Although W_{4,5} is used as an example in the following description, other food loss coefficients can be calculated by a flow of similar processing.

In S101, the data processing unit 130 inputs consumption data (for example, POS data) and shipping data (for example, statistical data of Ministry of Agriculture, Forestry and Fisheries) from the consumption DB 110 and the shipping DB 120, respectively.

In S102, the data processing unit 130 categorizes the consumption data and the shipping data, and calculates daily or weekly consumption and shipping amounts for each category, for example, and aligns these pieces of data on the same time axis.

In S103, the loss coefficient estimation unit 140 calculates (estimates) the time-series data of W_{4,5} using the above-described Formula 1. The time-series data of W_{4,5} is stored in the loss coefficient storage unit 220.

In S104, the loss coefficient model construction unit 210 inputs the time-series data of the food loss coefficient from the loss coefficient storage unit 220, inputs time-series data of temperature or the like from the time-series model parameter DB 230, and constructs (trains) the model W_{4,5} (t, x₁, . . . , xⱼ) of the food loss coefficient using the data.

In S105, the number of days ahead to be predicted is input to the model prediction unit 240. In the model prediction unit 240, the past W_{4,5} and time-series data of each of the past model parameters x₁, . . . , xⱼ are input to the trained model, and the model prediction unit 240 outputs a predicted value of the time-series data of W_{4,5} until a designated future day.

In S106, the MFA unit 150 predicts food loss using the food loss coefficient predicted in the model prediction unit 240. For example, the above-described Formulas 3, 4, and 5, and the like can be used. In S107, the output unit 170 outputs the predicted value of the food loss predicted in S106.

### (Hardware Configuration Example)

The food loss prediction device 100 and the food loss coefficient prediction device 200 can both be implemented by, for example, causing a computer to execute a program. The computer may be a physical computer or a virtual machine on a cloud. Hereinafter, the food loss prediction device 100 and the food loss coefficient prediction device 200 are collectively referred to as a “device”.

That is, the device can be implemented by executing a program corresponding to processing performed by the device using hardware resources such as a CPU and a memory contained in a computer. The foregoing program can be recorded on a computer-readable recording medium (a portable memory or the like) which is stored or distributed. The foregoing program can also be provided through a network such as the Internet or an e-mail.

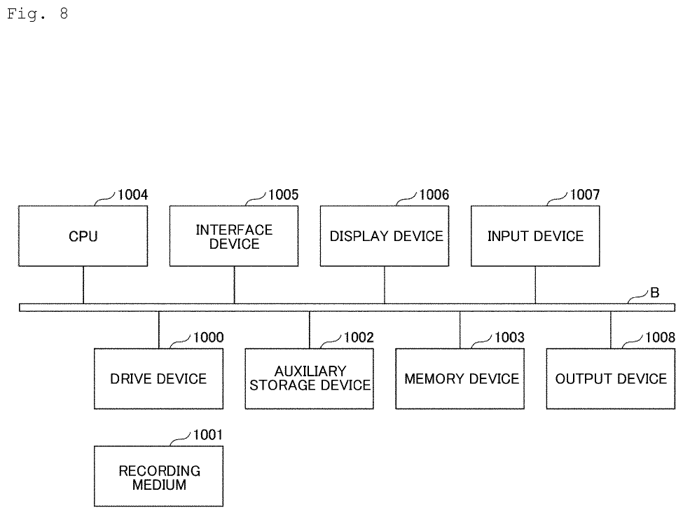

FIG. 8 is a diagram illustrating a hardware configuration example of the computer. The computer in FIG. 8 includes a drive device 1000, the auxiliary storage device 1002, the memory device 1003, a CPU 1004, an interface device 1005, a display device 1006, an input device 1007, and an output device 1008 which are connected to each other through a bus BS. Some of the devices may not be included. For example, when display is not performed, the display device 1006 may not be included.

The program for implementing the processing in the computer is provided by, for example, a recording medium 1001 such as a CD-ROM or a memory card. When the recording medium 1001 in which the program is stored is set in the drive device 1000, the program is installed from the recording medium 1001 to the auxiliary storage device 1002 via the drive device 1000. However, the program need not necessarily be installed from the recording medium 1001 and may be downloaded from another computer via a network. The auxiliary storage device 1002 stores the installed program and also stores necessary files, data, and the like.

The memory device 1003 reads and stores the program from the auxiliary storage device 1002 when an instruction to start the program is given. The CPU 1004 implements a function related to the device in accordance with the program stored in the memory device 1003. The interface device 1005 is used as an interface for connection to a network, and functions as a transmission unit and a reception unit. The display device 1006 displays a graphical user interface (GUI) or the like according to the program. The input device 1007 includes a keyboard and mouse, buttons, and a touch panel, and is used to input various operation instructions. The output device 1008 outputs a calculation result.

### (Effects of Embodiments)

According to the technique according to the embodiment described above, the predicted resolution of the food loss coefficient and the food loss can be improved from a coarse resolution such as one year to a high temporal resolution in units of, for example, a daily basis reflecting the consumption trend.

The high resolution can be implemented in this way. By providing information regarding a food group exposed a risk of waste to a producer, a consumer and a policy maker, it is possible to redirect surplus food through prediction and generate a dynamic strategy for reducing loss.

In the present embodiment, since the model is constructed using a nonlinear time-series modeling algorithm such as LSTM and a Gaussian process, a nonlinear event related to food loss can be modeled.

In the present embodiment, the model is constructed using other time-series data such as temperature, and social emotion derived from social media and news in addition to a food loss coefficient with a high time resolution (for example, a highest time resolution is one day). Therefore, it is possible to implement high prediction accuracy.

### (Supplements)

The following supplements are disclosed according to the foregoing embodiments.

### (Supplement 1)

A prediction device including:
an acquisition unit configured to acquire time-series data of a food loss coefficient and one time-series model parameter or a plurality of time-series model parameters; and
a model construction unit configured to construct a time-series model for predicting a future food loss coefficient using the time-series data of the food loss coefficient and the one time-series model parameter or the plurality of time-series model parameters.

### (Supplement 2)

The prediction device according to Supplement 1, further including:
a prediction unit configured to predict time-series data of the future food loss coefficient by inputting time-series data of a past food loss coefficient and one past time-series model parameter or a plurality of past time-series model parameters to the time-series model constructed by the model construction unit.

### (Supplement 3)

The prediction device according to Supplement 2, further including:
an analysis unit configured to predict future food loss using the time-series data of the food loss coefficient predicted by the prediction unit.

### (Supplement 4)

The prediction device according to any one Supplements 1 to 3, wherein the time-series model is a nonlinear time-series model.

### (Supplement 5)

A model construction method including:
an acquisition step of acquiring time-series data of a food loss coefficient and one time-series model parameter or a plurality of time-series model parameters; and
a model construction step of constructing a time-series model for predicting a future food loss coefficient using the time-series data of the food loss coefficient and the one time-series model parameter or the plurality of time-series model parameters.

### (Supplement 6)

A non-transitory recording medium that stores a program causing a computer to function as the units of the prediction device according to any one of Supplements 1 to 4.

Although the embodiment has been described above, the present invention is not limited to the specific embodiment, and various modifications and changes can be made within the scope of the gist of the present invention described in the claims.

### REFERENCE LITERATURE

[1] FAO, “Global Food Losses and Food Waste”. Food and Agriculture Organization of the United Nations, 2011. [Online]. Available: http://www.fao.org/3/12697e/i2697e.pdf
[2] I. FAO, The State of Food Security and Nutrition in the World 2021: Transforming food systems for food security, improved nutrition and affordable healthy diets for all. Rome, Italy: FAO, 2021. doi: 10.4060/Cb4474en.
[3] United Nations, “Transforming our world: the 2030 Agenda for Sustainable Development. Report No. A/RES/70/1.”, United Nations, New York, USA, 2015.
[4] C. Caldeira, V. De Laurentiis, S. Corrado, F. van Holsteijn, and S. Sala, “Quantification of food waste per product group along the food supply chain in the European Union: a mass flow analysis”, Resources, Conservation and Recycling, vol. 149, pp. 479-488, October 2019, doi: 10.1016/j. resconrec. 2019.06. 011.
[5] “Impact of food wastage on water resources and GHG emissions in Korea: A trend-based prediction modeling study-ScienceDirect”. https://www.sciencedirect.com/science/article/abs/pii/S0959652620326093 (accessed Mar. 14, 2022).
[6] Ministry of Agriculture, Forestry and Fisheries, “Crop statistics. https://www.maff.go.jp/j/tokei/kouhyou/sakumotu/index.html”, 2021.
[7] Shopper Insight, “Real Shopper SM”, 2021. [Online]. Available: http://shopperinsight.co.jp/service/

### REFERENCE SIGNS LIST

100 Food loss prediction device
110 Consumption DB
120 Shipping DB
130 Data processing unit
140 Loss coefficient estimation unit
150 MFA unit
160 Production DB
170 Output unit
180 Input unit
200 Food loss coefficient prediction device
210 Loss coefficient model construction unit
220 Loss coefficient storage unit
230 Time-series model parameter DB
240 Model prediction unit
250 Model storage unit
1000 Drive device
1001 Recording medium
1002 Auxiliary storage device
1003 Memory device
1004 CPU
1005 Interface device
1006 Display device
1007 Input device
1008 Output device

1. A prediction device comprising:
a hardware processor configured to
acquire time-series data of a food loss coefficient and one time-series model parameter or a plurality of time-series model parameters; and
construct a time-series model for predicting a future food loss coefficient using the time-series data of the food loss coefficient and the one time-series model parameter or the plurality of time-series model parameters.

2. The prediction device according to claim 1, wherein the hardware processor is further configured to predict time-series data of the future food loss coefficient by inputting time-series data of a past food loss coefficient and one past time-series model parameter or a plurality of past time-series model parameters to the constructed time-series model.

3. The prediction device according to claim 2, wherein the hardware processor is further configured to predict future food loss using the predicted time-series data of the food loss coefficient.

4. The prediction device according to claim 1, wherein the time-series model is a nonlinear time-series model.

5. A model construction method executed by a computer, comprising:
acquiring time-series data of a food loss coefficient and one time-series model parameter or a plurality of time-series model parameters; and
constructing a time-series model for predicting a future food loss coefficient using the time-series data of the food loss coefficient and the one time-series model parameter or the plurality of time-series model parameters.

6. A non-transitory computer-readable recording medium storing a program for causing a computer to execute a process, the process comprising:
acquiring time-series data of a food loss coefficient and one time-series model parameter or a plurality of time-series model parameters; and
constructing a time-series model for predicting a future food loss coefficient using the time-series data of the food loss coefficient and the one time-series model parameter or the plurality of time-series model parameters.
